(19) United States
(12) Patent Application Publication
(10) Pub. No.: US 2025/0191124 A1
(43) Pub. Date: Jun. 12, 2025

(54) MACHINE LEARNING ENABLED RESTORATION OF LOW RESOLUTION IMAGES

(71) Applicant: Genentech, Inc., South San Francisco, CA (US)

(72) Inventors: Anitha Priya KRISHNAN, Belmont, CA (US); Zhuang SONG; Richard Alan Duray CARANO, San Ramon, CA (US)

(21) Appl. No.: 18/842,230

(22) PCT Filed: Feb. 28, 2023
(86) PCT No.: PCT/US2023/014161

§ 371 Date: Aug. 28, 2024

Related U.S. Application Data
(60) Provisional application No. 63/314,991, filed on Feb. 28, 2022.

(51) Int. Cl. G06T 3/4046; G06T 3/4053

(52) U.S. Cl. CPC G06T 3/4046; G06T 3/4053

(57) ABSTRACT

A method may include training a machine learning model to reconstruct, based at least on a first image having a first spatial resolution, a second image having a second spatial resolution lower than the first spatial resolution. The reconstruction may include an iterative up-projection and down-projection of the second image to generate a third image having a third spatial resolution higher than the second spatial resolution. The training may include adjusting the machine learning model to minimize a first error between a target image having a target resolution and the third image and a second error between the second image and a fourth image generated by down-projection of a first up-projection of the second image. The method may also include applying the trained machine learning model to increase a spatial resolution of one or more images. Related methods and articles of manufacture are also disclosed.

### CROSS-REFERENCE TO RELATED APPLICATIONS

The present application claims priority to U.S. Provisional Application No. 63/314,991, filed Feb. 28, 2023, and entitled, “Machine Learning Enabled Restoration of Low Resolution Images,” the entirety of which is incorporated by reference herein.

### FIELD

The present disclosure generally relates to machine learning and more specifically to machine learning enabled restoration of low resolution images.

### BACKGROUND

Magnetic resonance imaging can provide information about tissue structure and function without inducing ionizing radiation. Thus, magnetic resonance imaging of the brain can be used for assessing various neurological disorders, such as Alzheimer's disease and Multiple Sclerosis. During magnetic resonance imaging, T₁-weighted and T₂-weighted magnetic resonance imaging sequences can be obtained using varying scan times. However, due at least to the complexity of obtaining such magnetic resonance imaging sequences, it can be difficult to obtain high resolution images.

As an example, when managing Alzheimer's disease and Multiple Sclerosis, magnetic resonance imaging images, including a high resolution T₁-weighted magnetic resonance image with isotropic ˜1 mm resolution and a lower resolution T₂-weighted image and/or a T₂-weighted fluid attenuated inversion recovery image can be obtained. While the T₁-weighted images and the T₂-weighted images may have similar in-plane resolution, the slice thickness of T₂-weighted images may be poor, making it difficult to ascertain edges and clear contrast in such images.

Spatial resolution thus plays an important role in quantitative assessment of various structures from magnetic resonance imaging images, such as during atrophy and lesion quantification. The low resolution images may be frequently interpolated to match the high resolution acquisition during the assessment. However, such upsampling does not add the missing high-frequency information to improve the resolution of low resolution images.

### SUMMARY

Methods, systems, and articles of manufacture, including computer program products, are provided for machine learning enabled restoration of low resolution images. In one aspect, there is provided a system. The system may include at least one processor and at least one memory. The at least one memory may store instructions that result in operations when executed by the at least one processor. The operations may include: training a machine learning model to reconstruct, based at least on a first image having a first spatial resolution, a second image having a second spatial resolution lower than the first spatial resolution. The reconstruction may include an iterative up-projection and down-projection of the second image to generate a third image having a third spatial resolution higher than the second spatial resolution. The training may include adjusting the machine learning model to minimize a first error between a target image having a target resolution and the third image and a second error between the second image and a fourth image generated by down-projection of a first up-projection of the second image. The operations may also include applying the trained machine learning model to increase a spatial resolution of one or more images.

In some variations, one or more of the features disclosed herein including the following features can optionally be included in any feasible combination. In some variations, the iterative up-projection and down-projection includes: up-projecting the second image to generate the first up-projection having a higher spatial resolution than the second image. The iterative up-projection and down-projection may also include extracting, from the first image, a first feature identified as a relevant feature during the up-projecting of the second image. The iterative up-projection and down-projection may also include down-projecting a concatenation of the first up-projection of the second image and the first feature to generate a first down-projection having a lower spatial resolution than the first up-projection and/or the second image. The iterative up-projection and down-projection may also include up-projecting the first down-projection to generate a second up-projection having a higher spatial resolution than the first down-projection. The iterative up-projection and down-projection may also include generating, based at least on the second up-projection and the first feature, the third image.

In some variations, the first down-projection is subjected to an additional iteration of up-projection and down-projection before being up-projected to generate the second up-projection. The third image may further be generated based on a second feature of the first image identified during the additional iteration of up-projection and down-projection.

In some variations, the machine learning model includes an alternating sequence of up-projection units and down-projection units configured to perform the iterative up-projection and down-projection.

In some variations, each up-projection unit and down-projection unit of the alternating sequence comprises a plurality of three dimensional kernels configured to extract three dimensional features.

In some variations, the reconstruction of the second image further includes combining an up-projection of the second image with one or more features of the first image identified during the iterative up-projection and down-projection of the second image.

In some variations, the combining is performed by concatenation and/or multiplicative attention.

In some variations, the first image and the second image include three-dimensional images.

In some variations, the first image is associated with a T₁-weighted magnetic resonance imaging sequence, and the second image is associated with a T₂-weighted magnetic resonance imaging sequence.

In some variations, the first spatial resolution corresponds to a first slice thickness along a z-axis, and the second spatial resolution corresponds to a second slice thickness along the z-axis.

In some variations, the fourth image is generated by at least concatenating a plurality of features extracted from the second image during the down-projecting of the first up-projection.

In some variations, the third image is generated by at least concatenating one or more features of the first image identified during the iterative up-projection and down-projection of the second image and/or one or more other features of the first image.

In some variations, the adjusting of the machine learning model is performed based on a loss function having a first term corresponding to the first error and a second term corresponding to the second error.

In some variations, the loss function further includes a third term corresponding to a third error between a first edge present in the first image and a second edge present in the third image. The training of the machine learning model may further include adjusting the machine learning model to minimize the third error.

In some variations, the loss function includes a Fourier loss function that measures a difference between two images based on Fourier transformations of the two images.

In some variations, the machine learning model is a deep back-projection network.

In some variations, a first down-projection unit of the alternating sequence outputs a feature extracted from the second image during the down-projecting of the first up-projection.

In another aspect, there is provided a method for machine learning enabled restoration of low resolution images. The method may include: training a machine learning model to reconstruct, based at least on a first image having a first spatial resolution, a second image having a second spatial resolution lower than the first spatial resolution. The reconstruction may include an iterative up-projection and down-projection of the second image to generate a third image having a third spatial resolution higher than the second spatial resolution. The training may include adjusting the machine learning model to minimize a first error between a target image having a target resolution and the third image and a second error between the second image and a fourth image generated by down-projection of a first up-projection of the second image. The method may also include applying the trained machine learning model to increase a spatial resolution of one or more images.

In another aspect, there is provided a computer program product that includes a non-transitory computer readable storage medium. The non-transitory computer-readable storage medium may include program code that causes operations when executed by at least one processor. The operations may include: training a machine learning model to reconstruct, based at least on a first image having a first spatial resolution, a second image having a second spatial resolution lower than the first spatial resolution. The reconstruction may include an iterative up-projection and down-projection of the second image to generate a third image having a third spatial resolution higher than the second spatial resolution. The training may include adjusting the machine learning model to minimize a first error between a target image having a target resolution and the third image and a second error between the second image and a fourth image generated by down-projection of a first up-projection of the second image. The operations may also include applying the trained machine learning model to increase a spatial resolution of one or more images.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to machine learning enabled restoration of low resolution images, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example super resolution system, consistent with implementations of the current subject matter;

FIG. 2 depicts a network diagram illustrating a super resolution system, consistent with implementations of the current subject matter;

FIG. 3A depicts a flowchart illustrating an example of a process for machine learning enabled restoration of low resolution images, consistent with implementations of the current subject matter;

FIG. 3B depicts a flowchart illustrating an example of a process for training a machine learning to restore low resolution images, consistent with implementations of the current subject matter;

FIG. 4A depicts a performance comparison of machine learning models and approaches;

FIG. 4B depicts a performance comparison of machine learning models and approaches; and

FIG. 5 depicts a block diagram illustrating an example of a computing system, consistent with implementations of the current subject matter.

When practical, like labels are used to refer to same or similar items in the drawings.

### DETAILED DESCRIPTION

Super resolution can help to restore or enhance high frequency details lost in low resolution magnetic resonance imaging images or other acquired images. For example, super resolution can be used to recover a high resolution image based on a low resolution image. Generally, deep learning models may be used for super resolution, such as single image super resolution. However, many deep learning models often rely on two-dimensional features and operate in a pre-processing (e.g., pre-upsampling) or progressive setting. Such super resolution approaches may inefficiently use high computing resources and have increased memory requirements.

For example, residual learning can be used to alleviate the degradation of high frequency details with deep networks by using skip connections locally and/or globally. These methods operate on two-dimensional or three-dimensional patches, but frequently upsample the low resolution images with bicubic interpolation before passing as input to the deep networks. Such pre-upsampling super resolution approaches significantly increase the memory requirements for three-dimensional machine learning models. Bicubic interpolation also leads to blurred edges and blocking artifacts, especially along the z-axis. As a result, machine learning models that refine features of low resolution images have generally been used for magnetic resonance imaging of the brain in two dimensions, rather than three-dimensions. The super resolution controller consistent with implementations of the current subject matter may improve the spatial resolution of low resolution images, such as low resolution magnetic resonance imaging images, making it easier to ascertain edges and clear contrast in such images.

Using deep neural networks, single image super resolution may also be used to construct high resolution images by learning non-linear mapping between the low resolution and high resolution images. These deep neural networks rely on upsampling layers to increase the resolution of the low resolution image and to reconstruct the high resolution image. Such deep neural networks have only feed-forward connections that poorly represent the low resolution to high resolution relation, especially for large scaling factors. Iterative back-projection, alone, may also be used to iteratively determine the reconstruction error to tune the quality of the high resolution reconstructed image. However, the resulting high resolution image still suffers from lack of clarity and other defects, and can be highly sensitive to the number of iterations and blur operator, among other parameters, leading to inconsistent results.

Moreover, single image super resolution machine learning models trained with voxel-wise loss in the image domain while improving the signal-to-noise ratio frequently fail to capture the finer details in the reconstructed images. In some instances, gradient guidance may improve the reconstruction of high frequency information in super resolution of brain MRI using image based or deep learning approaches. Complementary information from multimodal magnetic imaging sequences have been used by concatenation of additional high resolution images at the input level and by using fusion models along multiple stages of the deep learning network in pre-upsampling models or at an intermediary level that feeds into a refinement sub-network in post-upsampling methods. However, such approaches have generally increased memory requirements and decreased memory efficiency.

The super resolution controller consistent with implementations of the current subject matter may train and apply a machine learning model, such as a deep back projection network (e.g., a multi-branch deep back projection network) that improves anisotropic single image super resolution of three-dimensional brain magnetic resonance imaging sequences. For example, the machine learning model consistent with implementations of the current subject matter may work with multimodal inputs in a post-upsampling setting, increasing memory efficiency. The machine learning model may also be extended with three-dimensional kernels, further increasing the clarity and reducing dual domain losses in the frequency and spatial domains of the high resolution reconstructed images. Additionally and/or alternatively, the super resolution controller may train the machine learning model using at least a reverse mapping module that incorporates the features from down-projection blocks. Additionally and/or alternatively, the super resolution controller may train and/or apply the machine learning model using a separate branch to extract and combine relevant features from high resolution images at multiple points in the deep back projection network by concatenation and/or multiplicative attention. Additionally and/or alternatively, the super resolution controller may train and/or apply the machine learning model using gradient guidance by adding a loss term on the estimated edge maps from super-resolved images and the high resolution target or the complementary high resolution image. One or more of such tightly integrated features of the machine learning model improve the reconstruction of high frequency information.

As an example, the super resolution controller consistent with implementations of the current subject matter may train a machine learning model to reconstruct, based at least on a first image having a first spatial resolution, a second image having a second spatial resolution lower than the first spatial resolution. The reconstruction may include an iterative up-projection and down-projection of the second image to generate a third image having a third spatial resolution higher than the second spatial resolution. The training may include adjusting the machine learning model to minimize a first error between a target image having a target resolution and the third image and a second error between the second image and a fourth image generated by down-projection of a first up-projection of the second image. The super resolution controller may apply the trained machine learning model to increase a spatial resolution of one or more images, such as one or more low resolution images.

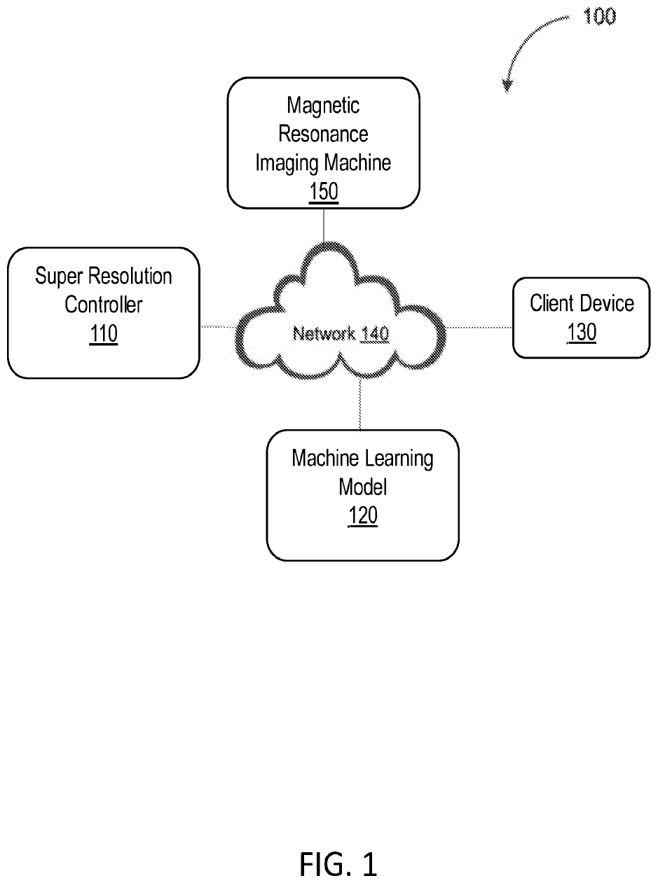

FIG. 1 depicts a system diagram illustrating an example of a super resolution system 100, consistent with implementations of the current subject matter. Referring to FIG. 1, the super resolution system 100 may include a super resolution controller 110, a machine learning model 120, a client device 130, and a magnetic resonance imaging machine 150. The super resolution controller 110, the machine learning model 120, and the client device 130 may be communicatively coupled via a network 140. The network 140 may be a wired network and/or a wireless network including, for example, a wide area network (WAN), a local area network (LAN), a virtual local area network (VLAN), a public land mobile network (PLMN), the Internet, and/or the like. In some implementations, the super resolution controller 110, the machine learning model 120, and/or the client device 130 may be contained within and/or operate on a same device.

It should be appreciated that the client device 130 may be a processor-based device including, for example, a smartphone, a tablet computer, a wearable apparatus, a virtual assistant, an Internet-of-Things (IoT) appliance, and/or the like. The client 130 may form a part of, include, and/or be coupled to a magnetic resonance imaging machine.

The magnetic resonance imaging machine 150 may generate an image, such as an image of a brain of a patient. The image may include a sequence or volume. The image may be a three-dimensional image, such as a three-dimensional image of the brain of the patient. In some implementations, the magnetic resonance imaging machine 150 generates a plurality of images using a plurality of modalities. The plurality of modalities may include a T₁-weighted magnetic resonance imaging sequence, a T₂-weighted magnetic resonance imaging sequence, and/or the like. The T₁-weighted imaging sequence and/or the T₂-weighted imaging sequence may use a fluid attenuated inversion recovery magnetic resonance image sequence, or the like to generate a T₁-weighted image and/or a T₂-weighted image. Images from the plurality of modalities may be acquired because, for example, inflammatory lesions may be seen in T₂-weighted images and may not be clearly seen in T₁-weighted images.

The plurality of modalities may generate images having a different slice thickness, which indicates a resolution of the images. The plurality of modalities may additionally or alternatively generate images having similar or the same in-plane resolution (e.g., along the x-axis and/or the y-axis). In other words, an edge present in one image generated using one of the plurality of modalities may correspond to an edge present in another image generated using another one of the plurality of modalities.

In some implementations, however, a spatial resolution of the images generated using the plurality of modalities may be different from one another. The spatial resolution may correspond to a voxel size and/or a pixel size along an x-axis, a y-axis, and/or a z-axis. In some implementations, the spatial resolution corresponds only to the x-axis and the y-axis. As another example, the spatial resolution may correspond to a slice thickness along a z-axis. The spatial resolution of each of the images may correspond to a different slice thickness along the z-axis. As an example, the T₁-weighted image may have a different (e.g., greater) spatial resolution from the T₂-weighted image and/or the fluid attenuated inversion recovery image T₂-weighted image. In other words, the T₁-weighted image may be a high resolution image. The T₂-weighted image and/or the fluid attenuated inversion recover image T₂-weighted image may have a lower spatial resolution than the T₁-weighted image. In other words, the T₂-weighted image may be a low resolution image such that a physical voxel dimension along the z-axis is lower (e.g., the sampling may be low and/or the signal along the z-axis may be missing). In some instances, T₂-weighted magnetic resonance images have a lower spatial resolution and/or the same spatial resolution as the T₂-weighted fluid attenuated inversion recovery images, while T₂-weighted fluid attenuated inversion recovery images may be used to remove contribution from the cerebral spinal fluid to allow for lesions near the ventricles to be clearly shown.

In some implementations, the low resolution image (e.g., the T₂-weighted image) may be simulated based on the high resolution image (y). For example, edges in the high resolution image can be blurred and noise can be added to the high resolution image to simulate the low resolution image. The low resolution image (x) may be modeled using Equation (1) as follows:

$$x = D ( B * y ) + ε = {g}_{θ} y + ε ; {g}_{θ} = DB \qquad Equation 1$$

$$y = {f}_{w} ( x ) - ε \qquad Equation 2$$

where D denotes a down-sampling operation (as described in more detail below), B is a blur operator, ε is additive noise, and g_{θ} is the mapping from high resolution to low resolution, parametrized by θ. The high resolution image is modeled using Equation (2), where f_{w} is the mapping from low resolution to high resolution, parametrized by w. Learning based approaches may determine an optimal w by minimizing a loss function between reconstructed and actual high resolution images. The machine learning model 120 may be used to estimate the mapping of the reconstructed and actual high resolution images.

The super resolution controller 110 may receive the generated images from the plurality of modalities. For example, the super resolution controller 110 may receive a first image such as the T₁-weighted image (e.g., the high resolution image), and a second image such as the T₂-weighted image (e.g., the low resolution image). Based on the generated images, the super resolution controller 110 may train the machine learning model 120 to reconstruct the second image. The super resolution controller 110 may then apply the trained machine learning model 120 to improve the spatial resolution of one or more low resolution images generated by the magnetic resonance imaging machine 150.

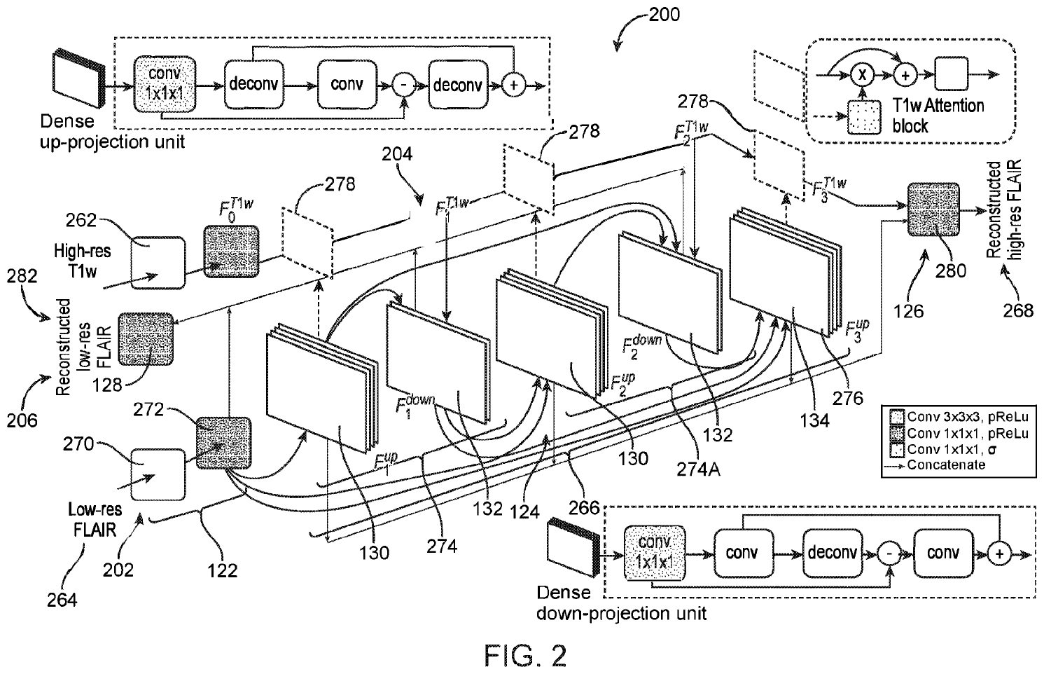

FIG. 2 schematically illustrates an example architecture 200 of the machine learning model 120. The super resolution controller 110 may train the machine learning model 120 using the architecture 200. The machine learning model 120 may include a deep back projection network, a deep learning neural network, and/or the like. The super resolution controller 110 may train the machine learning model 120 using a feature extraction module 122, a plurality of dense projection units 124 to perform an iterative up-projection and down-projection of a low resolution image (e.g., a second image 262), a reconstruction module 126 for reconstructing the low resolution image 262 to generate an image (e.g., a third image 268) having a higher spatial resolution, and a reverse mapping module 128 for reconstructing the low resolution image 262 and for improving the training of the machine learning model 120.

The feature extraction module 122 is located in a main branch 202 of the architecture 200 and uses a neural network to obtain feature maps in low resolution from the second image 264 (e.g., the low resolution image). The neural network may include one, two, three, four, five, or more neural networks. The neural network may include a filter, such as a 1×1×1 filter, a 3×3×3 filter, and/or the like. As shown in FIG. 2, the feature extraction module 122 uses a 3×3×3 and a 1×1×1 filter to obtain 32 feature maps in low resolution. However, it should be appreciated that other filters and filter sizes may be implemented. Additionally, it should be appreciated that any number of feature maps may be obtained by the feature extraction module 122, such as 1 to 5, 5 to 10, 10 to 15, 15 to 20, 20 to 30, 30 to 40, 40 to 50, or more, or other ranges therebetween.

The plurality of dense projection units 124 are used to facilitate easier propagation of gradients. The plurality of dense projection units 124 include a plurality of up-projection units 130 and a plurality of down-projection units 132. In some implementations, the plurality of dense projection units 124 includes at least one pair (e.g., one, two, three, four, five, or more pairs) of up-projection units 130 and down-projection units 132. In some implementations, the plurality of dense projection units 124 includes at least two pairs (e.g., two, three, four, five, or more pairs) of up-projection units 130 and down-projection units 132. Each up-projection unit and down-projection unit of the at least one pair or the at least two pairs may alternate. In other words, the machine learning model 120 may include an alternating sequence of the up-projection units 130 and the down-projection units 132. The alternating sequence may perform the iterative up-projection and down-projection, such as the iterative up-projection and down-projection of the second image 264.

The plurality of dense projection units 124 may also include an up-projection unit 134 after the at least one pair or the at least two pairs of up-projection units 130 and down-projection units 132. The up-projection unit 132 may be the final dense projection unit before reconstructing the high resolution image. The plurality of dense projection units 124 may receive an input from all previous ones of the plurality of dense projection units 124 of a different type For example, the down-projection units 132 (e.g., dense down-projection units) receive, as an input, an output of all previous up-projection units 130. The up-projection units 130 (e.g., dense up-projection units) may receive as an input, an output of all previous down-projection units 132 and/or one or more features extracted from the second image 264, such as by the feature extraction module 122.

The plurality of dense projection units 124 may include a convolutional layer and/or a transposed convolutional layer. The convolutional layer and/or the transposed convolutional layer may be followed by parametric rectified linear units with no batch normalization layers. For example, as shown in FIG. 2, the up-projection units 130 may include a transposed convolutional layer (e.g., indicated as “deconv” in FIG. 2), a convolutional layer (e.g., indicated as “conv” in FIG. 2), and/or another transposed convolutional layer. Further, as shown in FIG. 2, the down-projection units 132 may include a strided convolutional layer for down-sampling or down-projection (e.g., indicated as “conv” in FIG. 2), a transposed convolutional layer (e.g., indicated as “deconv” in FIG. 2), and/or another strided convolutional layer.

For scale factor of three along the slice dimension (e.g., along the z-axis), 7×7×7 kernels with an anisotropic stride of 1×1×3 were implemented with the plurality of dense projection units 124. For example, the plurality of dense projection units 124, such as the up-projection units 130 and/or the down-projection units 132 may include a plurality of three-dimensional kernels that extract three-dimensional features from an image being processed at the respective dense projection unit. The up-projection units 130 and/or the down-projection units 132 including the plurality of three-dimensional kernels further increases the clarity and reduces dual domain losses in the frequency and spatial domains of the reconstructed high resolution images 268.

The architecture 200 may additionally or alternatively include a second branch 204. The second branch may be used for multi-contrast single image super resolution. The super resolution controller 110 may use the second branch 204 to extract one or more relevant features from the high resolution image 262. The one or more features extracted from the high resolution image 262 may be identified as being relevant to improving the resolution (e.g., the spatial resolution) of the low resolution image. The one or more features extracted from the high resolution image 262 may be identified during the iterative up-projection and down-projection of the low resolution image, such as at the up-projection units 130.

The one or more relevant features from the first high resolution image 262 may be combined with one or more features from the main branch 202 at multiple locations (e.g., at the up-projection units 130, the down-projection units 132, and/or at the reconstruction module 126) using concatenation and/or multiplicative attention. In some implementations, the reconstruction module 126 may reconstruct the low resolution image 264 to generate a high resolution reconstructed image 268 by combining at least an up-projection of the second image 264 with the one or more features identified from the first image 262 (e.g., the high resolution image) during the iterative up-projection and down-projection of the low resolution image 264. The combining may be performed by concatenation and/or multiplicative attention. For example, the one or more features identified during the iterative up-projection and down-projection of the low resolution image may be combined by concatenation using Equation (3) below and/or by multiple attention using Equation (4) below:

$${F}_{t}^{T 1 w} = {F}_{t - 1}^{T 1 w} \qquad Equation 3$$

$${F}_{t}^{T 1 w} = {F}_{t - 1}^{T 1 w} ( 1 + σ ( c o n {v}_{1 \times 1} ( {F}_{t}^{u p} ) ) ) \qquad Equation 4$$

As described herein, the super resolution controller 110 may train the machine learning model 120 using the reconstruction module 126 to perform an iterative up-projection and down-projection of the low resolution image 264 to generate the high resolution reconstructed image 268 having a spatial resolution that is higher than the spatial resolution of the low resolution image 264. As shown in FIG. 2, the high resolution reconstructed image 268 having the spatial resolution that is higher than the spatial resolution of the low resolution image may include the reconstructed high resolution fluid attenuated inversion recovery image.

Consistent with implementations of the current subject matter, during the iterative up-projection and down-projection of the low resolution image, the super resolution controller 110 may apply at least one alternating pair of up-projection and down-projection operations, followed by a final up-projection operations. For example, the super resolution controller 110 may up-project, using a first up-projection unit of the up-projection units 130, the low resolution image to generate a first up-projection. The first up-projection may have a higher spatial resolution than the low resolution image. In some implementations, the spatial resolution of the first up-projection may be the same as the spatial resolution of the high resolution image 262. In other words, the spatial resolution of the first up-projection may be the same as the spatial resolution of the high resolution image 262. During the up-projection, the super resolution controller 110 may extract a first feature of the one or more features identified as a relevant feature from the high resolution image 262.

The super resolution controller 110 may then down-project, using a first down-projection unit of the down-projection units 132, a combination (e.g., a concatenation) of the first up-projection and one or more features (e.g., the first feature) identified as the relevant features from the high resolution image 262 to generate a first down-projection. The first down-projection may have a lower spatial resolution than the first up-projection and/or the low resolution image. In some implementations, the spatial resolution of the first down-projection may be the same as or greater than the spatial resolution of the low resolution image. In other words, the spatial resolution of the first down-projection may be lower than the first up-projection and at least the spatial resolution of the low resolution image.

In some implementations, the first down-projection is subjected to at least one additional iteration of up-projection and down-projection during which another up-projection and another down-projection are generated. When additional iterations of up-projection and down-projection are included, additional features identified as being relevant features from the high resolution image 262 may be combined by the reconstruction module 126.

As shown in FIG. 2, the super resolution controller 110 may up-project the first down-projection to generate a second up-projection after the first up-projection and the first down-projection and/or after the at least one additional iteration of up-projection and down-projection. The second up-projection may have a higher spatial resolution than the first down-projection. The second up-projection may have a spatial resolution that is the same as or similar to the spatial resolution of the high resolution image 262. The super resolution controller 110 may then generate the reconstructed high resolution image 268 having the higher spatial resolution based at least on the second up-projection and the one or more features (e.g., the first feature) identified as being relevant features from the high resolution image 262.

Referring again to FIG. 2, the architecture 200 may include a third branch 206. At the third branch 206, the super resolution controller 110 may use the reverse mapping module 128 to provide reverse mapping. In other words, the super resolution controller 110 may train the machine learning model 120 at least in part by reconstructing the low resolution image 264 (e.g., the low resolution image shown as the reconstructed low-res FLAIR in FIG. 2) to generate a low resolution reconstructed image 282 (e.g., a fourth image), such as during the iterative up-projection and down-projection. The super resolution controller 110 may reconstruct the low resolution image to generate the low resolution reconstructed image by performing concatenation to combine one or more features extracted by the down-projection units 132. The reverse mapping helps to minimize an error between the second image 264 (e.g., the low resolution image) and the low resolution reconstructed image 282. The reverse mapping additionally or alternatively helps to improve the training of the machine learning model 120, and/or the aid the machine learning model 120 in learning the forward and reverse mapping of the features of the described images. The reverse mapping additionally or alternatively helps to improve the restoration of fine details in the high resolution reconstructed image 268 (e.g., the third image). The reverse mapping may additionally or alternatively help to reduce computing resources and improve memory efficiency of the machine learning model 120.

The super resolution controller 110 may train the machine learning model 120 by at least applying a loss function. For example, the super resolution controller 110 may train the machine learning model 120 with L1 loss on both the low resolution reconstructed image 282 and the high resolution reconstructed image 268, and weighted L1 loss on discrete Fourier transform coefficients of the model reconstruction and a high resolution target image to better capture the high frequency information in the high resolution reconstructed image. As an example, the loss function may be represented by Equation (5) below:

$${L}_{S R} = \frac{1}{M} {\sum }_{i = 1}^{M} ( α {‖ {f}_{1} ( {x}_{i} ) - {x}_{i} ‖}_{1} + β {‖ {f}_{2} ( {x}_{i} ) - {y}_{i} ‖}_{1} + γ {\sum }_{k = 1}^{\frac{N}{2}} ( \frac{{\vert {\hat{μ}}_{i k} - {\hat{v}}_{i k} \vert}^{2}}{{\vert k \vert}^{2}} + η {‖ G ( f ( {x}_{i} ) ) - G ( {y}_{i} ) ‖}_{1} ) \qquad Equation 5$$

where M is a number of patches in the training set, \hat{μ} is the discrete Fourier transform coefficient of the reconstructed high resolution patch, \hat{ν} is a discrete Fourier transform coefficient of the target high resolution patch, k is a distance from a center of k-space, G is a Sobel operator in a three-dimensional space, f₁ is the low resolution mapping (e.g., reverse mapping along the branch 206) learned from the initial and concatenated down-projection features extracted during down-projection and f₂ is the forward high resolution mapping (e.g., along the branches 202, 204) learned from concatenated up-projection and high resolution complementary input features (e.g., the one or more features identified as relevant features from the first image).

As shown in Equation (5) above, the loss function may include a first term, a second term, a third term, and/or a fourth term. The first term may be a mean absolute error between the low resolution image 264 and the low resolution reconstructed image 282. The second term may be a mean absolute error between the target image (e.g., the high resolution target image) and the high resolution reconstructed image 268. The third term may be a mean absolute error between the Fourier coefficient of the high resolution target image and the high resolution reconstructed image 268. The fourth term may be a Sobel edge between the high resolution reconstructed image 268 and the target image (e.g., the high resolution target image) or the high resolution image (e.g., the first image). The super resolution controller 110 may adjust one or more weights of the first term, the second term, the third term, and/or the fourth term to minimize the individual error terms and/or a sum of the error terms.

In other words, the machine learning model 120 may be adjusted by the super resolution controller 110 to minimize an error between the low resolution image 264 and the low resolution reconstructed image 282. The machine learning model 120 may additionally or alternatively be adjusted by the super resolution controller 110 to minimize another error between the target image (e.g., the high resolution target image) and the high resolution reconstructed image 268. The machine learning model 120 may additionally or alternatively be adjusted by the super resolution controller 110 to minimize yet another error between the Fourier coefficient of the high resolution target image and the high resolution reconstructed image 268. The machine learning model 120 may additionally or alternatively be adjusted by the super resolution controller 110 to minimize yet another error between at least one edge between the high resolution reconstructed image 268 and the target image (e.g., the high resolution target image) or the high resolution image 262 (e.g., the first image).

In some implementations, the third term may include a Fourier loss function that measures a difference between two images based on Fourier transforms of the two images. The third term may be adjusted by weighting low frequency components of the images more than the high frequency components. For example, the inverse weighting of the Fourier loss with the distance from the center of k-space with low frequencies prevents the amplification of noise at higher frequencies. As a result, since down-projection of an image, such as by the down-projection units 132, corresponds to truncation in the Fourier domain, the third term linearly weights the truncated regions more than non-truncated regions.

In some implementations, the fourth term minimizes the L1 loss between the estimated Sobel edges of the high resolution reconstructed image 268 and the target image (e.g., the high resolution target image) or the high resolution image 262 (e.g., the first image) for gradient guidance. As such, the fourth term may include edge mapping between the high resolution reconstructed image 268 and the target image or the high resolution image 262. For example, the fourth term may correspond to an error between a first edge present in the high resolution image 262 or the target image and a second edge present in the high resolution reconstructed image 268. The super resolution controller 110 may train the machine learning model 120 by adjusting the machine learning model to minimize the error.

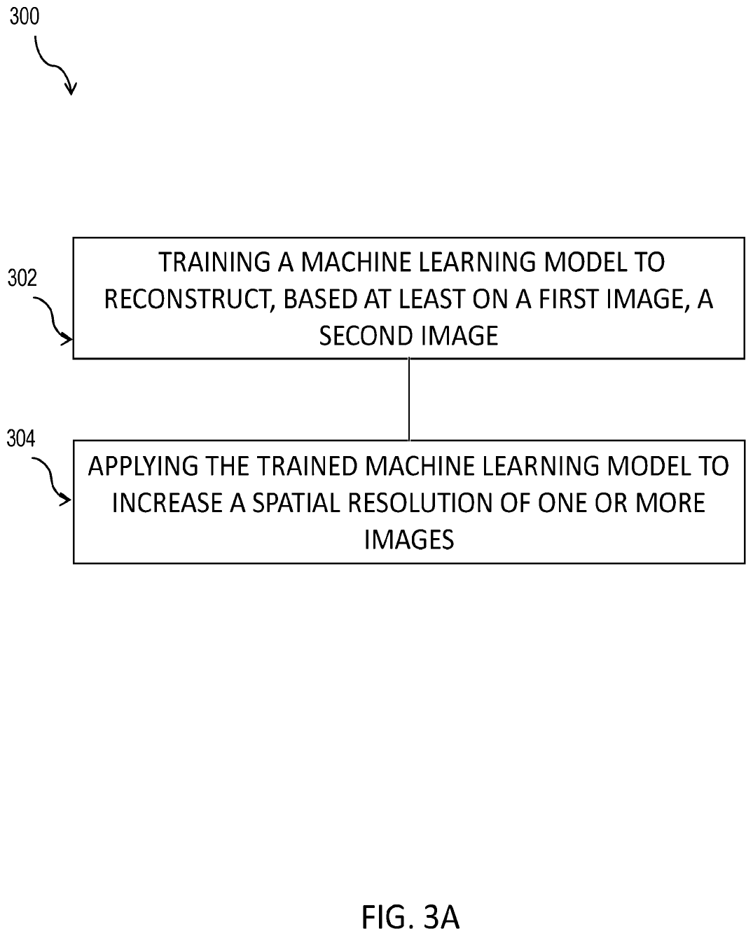

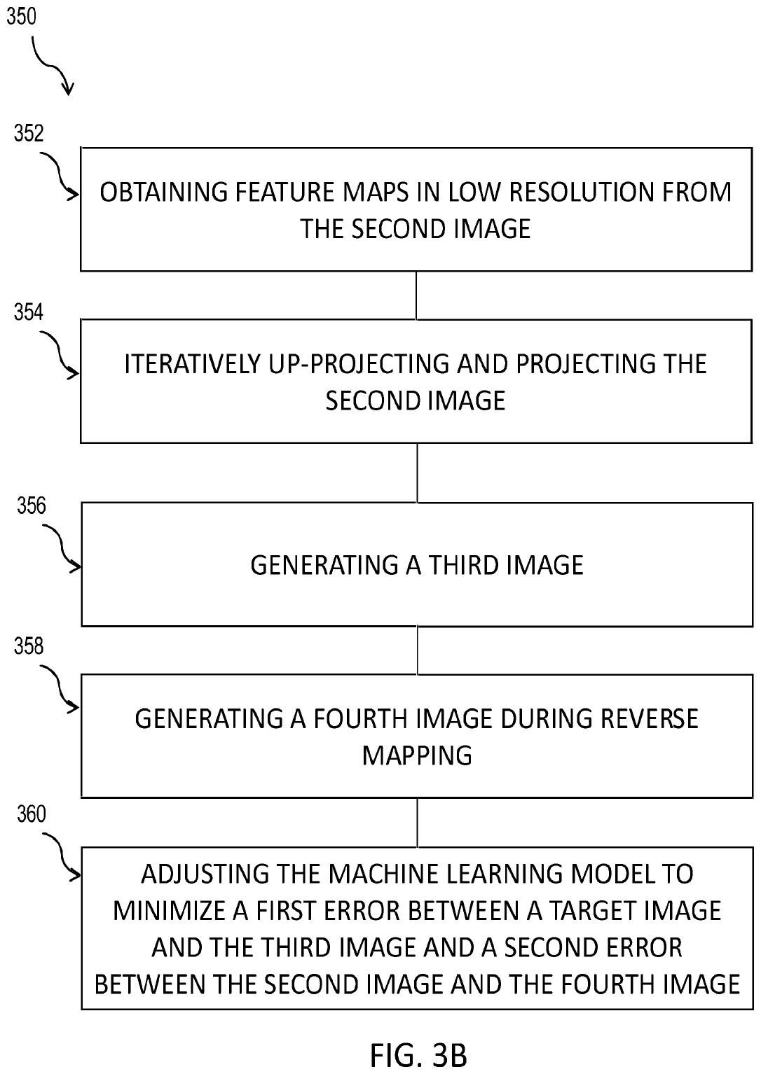

FIG. 3A depicts a flowchart illustrating an example of a process 300 for machine learning enabled restoration of low resolution images and improving the reconstruction of high frequency information, consistent with implementations of the current subject matter. FIG. 3B depicts a flowchart illustrating an example of a process 350 for training the machine learning model, consistent with implementations of the current subject matter. Referring to FIG. 3A and FIG. 3B, the processes 300, 350 may be performed by the super resolution controller 110 to restore low resolution images to increase the spatial resolution of the low resolution images. Accordingly, the super resolution controller may train the machine learning model using with multimodal inputs in a post-upsampling setting, increasing memory efficiency. Consistent with implementations of the current subject matter, the processes 300, 350 refer to the example architecture 200 shown in FIG. 2.

Referring to FIG. 3A, at 302, the super resolution controller (e.g., the super resolution controller 110) may train a machine learning model (e.g., the machine learning model 120) to reconstruct, based at least on a first image 262 having a first spatial resolution, a second image 264 having a second spatial resolution lower than the first spatial resolution. The first image 262 may include a high resolution image that is associated with a T₁-weighted magnetic resonance imaging sequence. The second image 264 may include a low resolution image, such as a low resolution fluid attenuated inversion recovery image, and/or a simulated low resolution image, consistent with implementations of the current subject matter. The super resolution controller 110 may receive the first image 262 and/or the second image 264 from a magnetic resonance imaging machine (e.g., the magnetic resonance imaging machine 150).

Referring to FIG. 3B, the super resolution controller 110 may train the machine learning model 120 using process 350. At 352, the super resolution controller 110 may obtain feature maps in low resolution from the second image 264. For example, the super resolution controller 110 may use a neural network to obtain the feature maps. The neural network may include a first filter 270 and a second filter 272 to extract the feature maps in low resolution.

At 354, the super resolution controller may reconstruct the second image to generate a third image 268 having a third spatial resolution higher than the second spatial resolution. The reconstruction of the second image 264 may include an iterative up-projection and down-projection 266 of the second image 264 to generate the third image 268. The third image 268 may include a high resolution reconstructed image, such as a reconstructed fluid attenuated inversion recovery image. The first spatial resolution, the second spatial resolution, and the third spatial resolution may each correspond to different spatial samplings and/or slice thicknesses along the x-axis, the y-axis, and/or the z-axis.

In some implementations, the iterative up-projection and down-projection 266 includes pairs of up-projecting and down-projecting operations 274 followed by an up-projecting operation 276. For example, the iterative up-projection and down-projection 266 includes up-projecting the second image 264 to generate a first up-projection (e.g., using the first up-projection unit 130) having a higher spatial resolution than the second image 264. The iterative up-projection and down-projection 266 may also include extracting, from the first image (at 278 along the branch 204), a first feature identified as a relevant feature during the up-projecting of the second image 264. For example, the super resolution controller 110 may use a separate branch 204 from the main branch 202 to extract and combine relevant features from high resolution images at multiple points in the architecture 200 by concatenation and/or multiplicative attention.

The iterative up-projection and down-projection 266 may also include down-projecting a concatenation of the first up-projection of the second image (e.g., using the first down-projection unit 132) and the first feature (e.g., the feature identified as the relevant feature during the up-projecting) to generate a first down-projection having a lower spatial resolution than the first up-projection and/or the second image 264. The iterative up-projection and down-projection 266 may also include up-projecting the first down-projection (e.g., using the up-projection unit 134) to generate a second up-projection having a higher spatial resolution than the first down-projection. The first down-projection may be subjected to an additional iteration of up-projection and down-projection 274A before being up-projected to generate the second up-projection (e.g., using the up-projection unit 134).

At 356, the super resolution controller 110 may generate the third image 268. For example, the super resolution controller 110 may generate the third image based at least on the second up-projection and the first feature identified as a relevant feature during the up-projecting of the second image 264. The third image 268 may further be generated based on a second feature of the first image identified during the additional iteration of up-projection and down-projection 274A. The super resolution controller 110 may generate the third image 268 (e.g., reconstruct the second image 264) by at least combining, at 280, an up-projection of the second image 264 with one or more features of the first image 262 identified during the iterative up-projection and down-projection 266 of the second image 264 using concatenation and/or multiplicative attention.

Referring to FIG. 3B, at 358, the super resolution controller 110 may generate a fourth image 282. The fourth image 282 may be generated during reverse mapping. In other words, the super resolution controller 110 may train the machine learning model using at least the reverse mapping module 128 that incorporates the features from down-projection units 132. For example, the fourth image 282 may be generated by at least concatenating a plurality of features extracted from the second image 264 during the down-projecting of the first up-projection (e.g., at down-projection unit 132). The super resolution controller 110 may generate the fourth image 282 at the same time as and/or at a different time from the iterative up-projection and down-projection 266. Consistent with implementations of the current subject matter, generation of the fourth image 282 may help to improve the training of the machine learning model 120.

Referring again to FIG. 3B, at 360, the super resolution controller 110 adjusts the machine learning model 120 to minimize a first error between a target image having a target resolution and the third image 268 and a second error between the second image 264 and the fourth image 282 generated by down-projection of a first up-projection of the second image 264. In some implementations the super resolution controller 110 additionally or alternatively trains the machine learning model 120 to minimize a third error between edge maps of the third image 268 and either the first image 262 or the target image. For example, the super resolution controller 110 may train and/or apply the machine learning model 110 using gradient guidance by adding a loss term to minimize error (e.g., the third error) on the estimated edge maps from super-resolved images and the high resolution target or the complementary high resolution image (e.g., the first image 262).

The adjusting of the machine learning may be performed based on a loss function (e.g., the loss function shown in Equation (5)). Consistent with implementations of the current subject matter, the loss function may have a first term corresponding to the first error, a second term corresponding to the second error, and/or a third term corresponding to the third error. The loss function may additionally or alternatively include a fourth term corresponding to a fourth error, or the like.

Referring back to FIG. 3A, at 304, the super resolution controller 110 may apply the trained machine learning model to increase a spatial resolution of one or more images. For example, as described herein, the magnetic resonance imaging machine may generate images using a plurality of modalities. Based on the modality, the image generated by the magnetic resonance imaging machine may have a low resolution. The super resolution controller 110 may apply the trained machine learning model to increase the spatial resolution of the image having the low spatial resolution to improve clarity and/or contrast in the image. This may help to improve detection of various neurological disorders in patients.

### Experiments

As an example, machine learning models, including a deep-back projection network (e.g., the machine learning model 120), a bicubic model, and a multi-stage integration network (MINet) were trained on three magnetic resonance imaging data sets from patients with Alzheimer's Disease or Multiple Sclerosis with T₁-weighted and fluid attenuated inversion recovery sequences acquired with ˜1 mm resolution. T₁-weighted images (e.g., the first image) and T₂-weighted fluid attenuated inversion recovery images (e.g., the second image) were acquired sagitally with a three-dimensional MPRAGE and SPACE sequence on a magnetic resonance imaging machine. The datasets were acquired from various scanners and multiple sites but with a standardized protocol. The final real-world dataset was obtained from a novel patient-centered study of patients with MS in the US across multiple sites. The training dataset (n=15) from the Multiple Sclerosis lesion segmentation challenge was used as the external test set. The low resolution images were simulated by randomly downsampling high resolution images after Gaussian blurring or truncating the k-space along the z-axis and adding Gaussian noise at 2-5% of the maximum intensity in the low resolution image. The machine learning models were trained with a three-fold cross-validation with splits at the patient level.

To train the machine learning models, the parameters α, β, γ, η were empirically set to 100, 100, 1 and 500, respectively. The patches were augmented on the fly during batch generation using affine transformations or elastic deformations. The model weights were optimized using Adam optimizer with an initial learning rate of 1e-4. PSNR, SSIM and high frequency error norm (HFEN) were used as evaluation metrics.

As shown in Table 1 below, the deep back-projection network performed better than MINet in improving the PSNR and SSIM metrics and consistently decreased HFEN indicating the restoration of fine structural details.

TABLE 1

| Model/ | | | | |
|---|---|---|---|---|
| approach | test set | PSNR↑ | SSIM ↑ | HFEN↓ |
| Bicubic | internal | 27.691 ± 1.328 | 0.824 ± 0.025 | 0.451 ± 0.065 |
| | external | 28.843 ± 2.477 | 0.885 ± 0.022 | 0.458 ± 0.053 |
| MINet [11] | internal | 26.554 ± 2.826 | 0.883 ± 0.041 | 0.37 ± 0.131 |
| | external | 27.211 ± 2.96 | 0.907 ± 0.032 | 0.309 ± 0.1 |
| MA-GG_{T1w} | internal | 26.967 ± 2.09 | 0.89 ± 0.024 | 0.293 ± 0.068 |
| | external | 27.66 ± 2.792 | 0.912 ± 0.015 | 0.276 ± 0.037 |
| MA-GG_{FLAIR} | internal | 27.283 ± 2.111 | 0.899 ± 0.023 | 0.255 ± 0.05 |
| | external | 28.039 ± 2.789 | 0.919 ± 0.015 | 0.265 ± 0.029 |

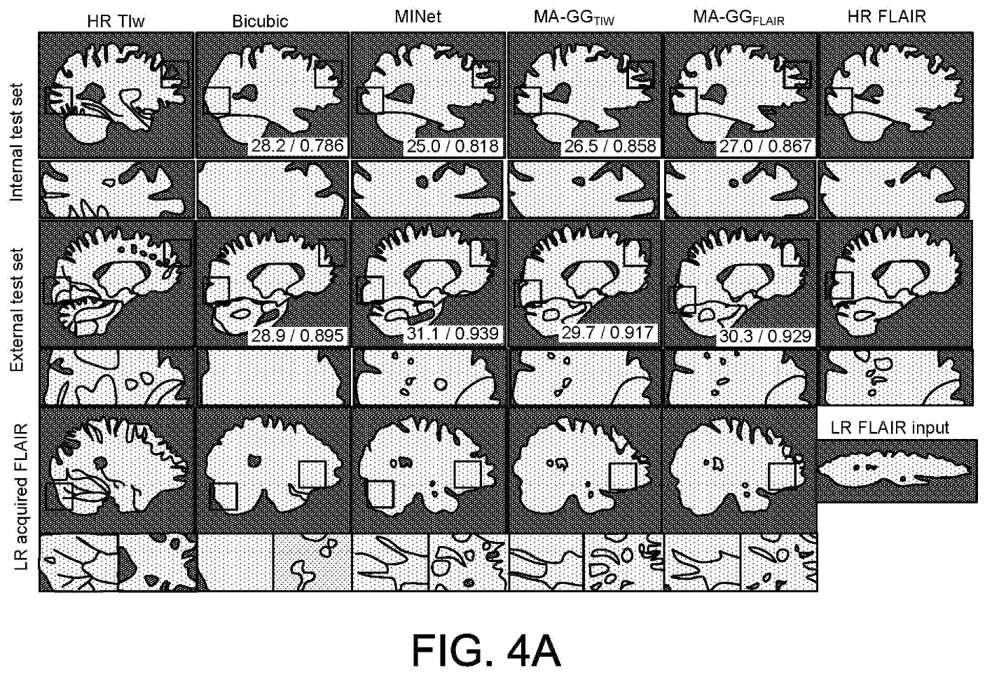

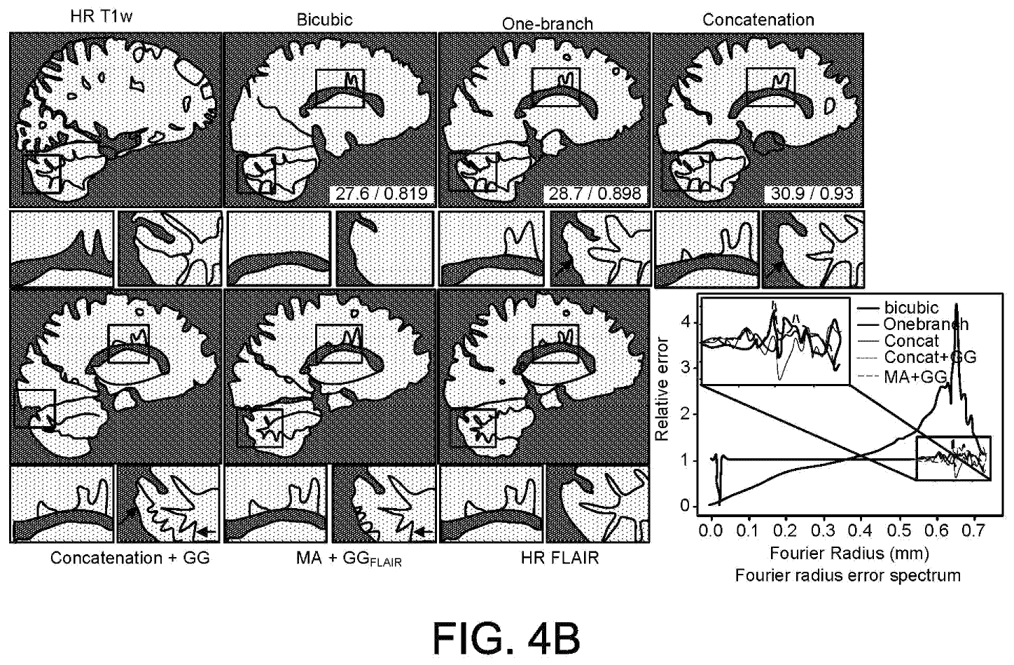

The trained models performed comparably across the Alzheimer's Disease and Multiple Sclerosis disease populations as can be seen in the qualitative results provided in FIG. 4, while the deep back projection network described herein reduced computing resources and increased memory efficiency. Referring to FIG. 4, the top row shows the single image super resolution results for an Alzheimer's Disease patient in the internal test set, the middle row includes the single image super resolution results for a Multiple Sclerosis patient in the external test set and the last row shows the application of the deep-back projection network consistent with implementations of the current subject matter on an acquired low resolution fluid attenuated inversion recovery image. From the magnified images shown in the bottom row, the deep-back projection network consistent with implementations of the current subject matter effectively de-noised the images, improving the contrast for lesions compared to bicubic interpolated images and adds more fine details in the high resolution reconstructed image.

### Ablation Studies

Ablation studies of the three-dimensional deep back projection network consistent with implementations of the current subject matter were evaluated on the internal test set with gradient guidance from the high resolution target fluid attenuated inversion recovery images. As shown in FIG. 4B and Table 2 below, the deep back projection network consistent with implementations of the current subject matter improved both PSNR and SSIM compared to a one branch network. Inclusion of gradient guidance and multiplicative attention recovered more of the finer details in the images, as shown in FIG. 4B.

TABLE 2

| # branches | Agg | GG | PSNR↑ | SSIM↑ | HFEN↓ |
|---|---|---|---|---|---|
| One | — | No | 27.117 ± 1.858 | 0.88 ± 0.022 | 0.276 ± 0.061 |
| Two | Concat | No | 28.079 ± 2.1 | 0.905 ± 0.023 | 0.222 ± 0.059 |
| Two | Concat | Yes | 26.85 ± 2.041 | 0.886 ± 0.024 | 0.274 ± 0.051 |
| Two | MA | Yes | 26.942 ± 2.109 | 0.871 ± 0.022 | 0.268 ± 0.046 |

In Table 2 above and in FIG. 4B, Concat is concatenation, MA is multiplicative attention, Agg is aggregation, GG is gradient guidance, and HFEN is high frequency error norm.

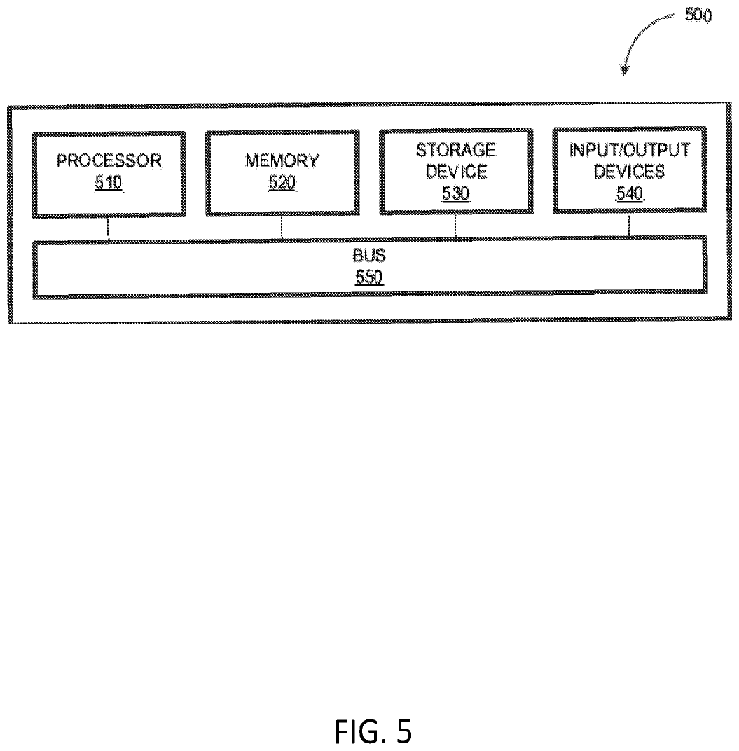

FIG. 5 depicts a block diagram illustrating a computing system 500 consistent with implementations of the current subject matter. Referring to FIGS. 1-5, the computing system 500 can be used to implement the super resolution controller 110, the machine learning model 120, and/or any components therein.

As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The computing system 500 may additionally or alternatively include a graphic processing unit (GPU), such as for image processing, and/or an associated memory for the GPU. The GPU and/or the associated memory for the GPU may be interconnected via the system bus 550 with the processor 510, the memory 520, the storage device 530, and the input/output devices 540. The memory associated with the GPU may store one or more images described herein, and the GPU may process one or more of the images described herein. The GPU may be coupled to and/or form a part of the processor 510. The processor 510 is capable of processing instructions for execution within the computing system 500. Such executed instructions can implement one or more components of, for example, the super resolution controller 110 and the machine learning model 120. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

1. A system, comprising:
at least one processor; and
at least one memory storing instructions which, when executed by the at least one processor, result in operations comprising:
training a machine learning model to reconstruct, based at least on a first image having a first spatial resolution, a second image having a second spatial resolution lower than the first spatial resolution, the reconstruction including an iterative up-projection and down-projection of the second image to generate a third image having a third spatial resolution higher than the second spatial resolution, and the training including:
adjusting the machine learning model to minimize a first error between a target image having a target resolution and the third image and a second error between the second image and a fourth image generated by down-projection of a first up-projection of the second image; and
applying the trained machine learning model to increase a spatial resolution of one or more images.

2. The system of claim 1, wherein the iterative up-projection and down-projection comprises:
up-projecting the second image to generate the first up-projection having a higher spatial resolution than the second image;
extracting, from the first image, a first feature identified as a relevant feature during the up-projecting of the second image;
down-projecting a concatenation of the first up-projection of the second image and the first feature to generate a first down-projection having a lower spatial resolution than the first up-projection and/or the second image;
up-projecting the first down-projection to generate a second up-projection having a higher spatial resolution than the first down-projection; and
generating, based at least on the second up-projection and the first feature, the third image.

3. The system of claim 2, wherein the first down-projection is subjected to an additional iteration of up-projection and down-projection before being up-projected to generate the second up-projection, and wherein the third image is further generated based on a second feature of the first image identified during the additional iteration of up-projection and down-projection.

4. The system of claim 1, wherein the machine learning model includes an alternating sequence of up-projection units and down-projection units configured to perform the iterative up-projection and down-projection, and wherein a down-projection unit of the alternating sequence outputs a feature extracted from the second image during the down-projecting of the first up-projection performed by a preceding up-projection unit.

5. The system of claim 4, wherein each up-projection unit and down-projection unit of the alternating sequence comprises a plurality of three dimensional kernels configured to extract three dimensional features.

6. The system of claim 1, wherein the reconstruction of the second image further includes combining an up-projection of the second image with one or more features of the first image identified during the iterative up-projection and down-projection of the second image.

7. The system of claim 6, wherein the combining is performed by concatenation and/or multiplicative attention.

8. The system of claim 1, wherein the first image and the second image comprise three-dimensional images.

9. The system of claim 1, wherein the first image is associated with a T₁-weighted magnetic resonance imaging sequence, and wherein the second image is associated with a T₂-weighted magnetic resonance imaging sequence.

10. The system of claim 1, wherein the first spatial resolution corresponds to a first slice thickness along a z-axis, and wherein the second spatial resolution corresponds to a second slice thickness along the z-axis.

11. The system of claim 1, wherein the fourth image is generated by at least concatenating a plurality of features extracted from the second image during the down-projecting of the first up-projection.

12. The system of claim 1, wherein the adjusting of the machine learning model is performed based on a loss function having a first term corresponding to the first error and a second term corresponding to the second error.

13. The system of claim 12, wherein the loss function further includes a third term corresponding to a third error between a first edge present in the first image and a second edge present in the third image, and wherein the training of the machine learning model further includes adjusting the machine learning model to minimize the third error.

14. The system of claim 12, wherein the loss function includes a Fourier loss function that measures a difference between two images based on Fourier transformations of the two images.

15. The system of claim 1, wherein the machine learning model is a deep back-projection network.

16. (canceled)

17. A method, comprising:
training a machine learning model to reconstruct, based at least on a first image having a first spatial resolution, a second image having a second spatial resolution lower than the first spatial resolution, the reconstruction including an iterative up-projection and down-projection of the second image to generate a third image having a third spatial resolution higher than the second spatial resolution, and the training including:
adjusting the machine learning model to minimize a first error between a target image having a target resolution and the third image and a second error between the second image and a fourth image generated by down-projection of a first up-projection of the second image; and
applying the trained machine learning model to increase a spatial resolution of one or more images.

18. The method of claim 17, wherein the iterative up-projection and down-projection comprises:
up-projecting the second image to generate the first up-projection having a higher spatial resolution than the second image;
extracting, from the first image, a first feature identified as a relevant feature during the up-projecting of the second image;
down-projecting a concatenation of the first up-projection of the second image and the first feature to generate a first down-projection having a lower spatial resolution than the first up-projection and/or the second image;
up-projecting the first down-projection to generate a second up-projection having a higher spatial resolution than the first down-projection; and
generating, based at least on the second up-projection and the first feature, the third image.

19. The method of claim 18, wherein the first down-projection is subjected to an additional iteration of up-projection and down-projection before being up-projected to generate the second up-projection, and wherein the third image is further generated based on a second feature of the first image identified during the additional iteration of up-projection and down-projection.

20. The method of claim 17, wherein the machine learning model includes an alternating sequence of up-projection units and down-projection units configured to perform the iterative up-projection and down-projection, and wherein a down-projection unit of the alternating sequence outputs a feature extracted from the second image during the down-projecting of the first up-projection performed by a preceding up-projection unit.

21-32. (canceled)

33. A non-transitory computer readable medium storing instructions, which when executed by at least one processor, result in operations comprising:
training a machine learning model to reconstruct, based at least on a first image having a first spatial resolution, a second image having a second spatial resolution lower than the first spatial resolution, the reconstruction including an iterative up-projection and down-projection of the second image to generate a third image having a third spatial resolution higher than the second spatial resolution, and the training including:
adjusting the machine learning model to minimize a first error between a target image having a target resolution and the third image and a second error between the second image and a fourth image generated by down-projection of a first up-projection of the second image; and
applying the trained machine learning model to increase a spatial resolution of one or more images.

34. (canceled)
